(19) United States
(12) Patent Application Publication
(10) Pub. No.: US 2015/0190883 A1
(43) Pub. Date: Jul. 9, 2015

(54) METHOD FOR CUTTING A SHEET METAL BLANK

(71) Applicant: SCHULER AUTOMATION GMBH & CO. KG, Hessdorf (DE)

(72) Inventor: Heinz Erlwein, Kunreuth (DE)

(21) Appl. No.: 14/414,726

(22) PCT Filed: Feb. 18, 2014
(86) PCT No.: PCT/EP2014/053140

§ 371 Date: Jan. 14, 2015

(30) Foreign Application Priority Data
Feb. 28, 2013 (DE) 10 2013 203 384.2

(51) Int. Cl. B23K 26/08; B23K 26/03; B23K 26/38

(52) U.S. Cl. CPC B23K 26/0846; B23K 26/38; B23K 26/03; B23K 26/0869

(57) ABSTRACT

A method for cutting a sheet metal blank from a sheet metal strip conveyed in a direction of transport includes the steps: providing a laser cutting device having a laser cutting head movable in the direction of transport and in a y-direction perpendicularly thereto and having a control arrangement for controlling the movement of the laser cutting head along a cutting path, continuously measuring a first distance of a first strip edge of the sheet metal strip from a fixed first measurement point in the y-direction by a first distance measuring arrangement provided upstream of the laser cutting device, transmitting first measured distance values to the control arrangement, calculating a corrected cutting path with use of a predefined cutting path and the first measured distance values by the control arrangement, and producing a cut in the sheet metal strip by moving the laser cutting head along the corrected cutting path.

The invention relates to a method for cutting a sheet metal blank with a predefined contour from a sheet metal strip conveyed continuously in a direction of transport.

U.S. Pat. No. 8,253,064 B2 and the document WO 2009/105608 A1 corresponding thereto disclose a method for cutting sheet metal blanks with a predefined contour from a sheet metal strip conveyed continuously in a direction of transport. To cut the sheet metal strip unwound from a coil, a laser cutting device having a plurality of laser cutting heads movable in the direction of transport and also in a y-direction running perpendicularly to the direction of transport is provided downstream of a reel. With the known method, the contour of a sheet metal blank is produced by means of the laser cutting heads arranged successively in the direction of transport by a number of consecutive partial contour cuts. In order to compensate for deviations of the sheet metal strip from a centreline defined by the laser cutting device, markings on the sheet metal strip are detected by means of a camera. From this, a deviation of the strip centre from the centreline is determined. The cutting paths of the laser cutting heads are corrected accordingly by means of a control program with use of the determined deviation. The provision of markings on the sheet metal strip is complex. Apart from that, markings can be damaged in practice prior to the detection thereof by the camera, or dirt deposits can be interpreted incorrectly as markings. This may lead consequently to significant disruptions during the production of the sheet metal blanks. Lastly, two successive markings are arranged at a distance in the direction of transport. The camera records each of the markings separately. The evaluation of the images captured by the camera is time-consuming. The known method is relatively slow.

JP 2001-105170 A discloses a further method for cutting a sheet metal blank from a sheet metal strip conveyed in a direction of transport. Here, a sensor for detecting the position of the strip edge is provided upstream of a laser cutting device. For correction of the position of the strip edge, a reel provided upstream of the sensor is moved transversely to the direction of transport of the sheet metal strip by means of a suitable controller depending on the values delivered by the sensor. A complex movement arrangement is necessary in order to move the usually several tons of heavy reel. The known method for correcting the position of the strip edge is relatively slow.

The object of the invention is to overcome the disadvantages according to the prior art. In particular, a method is to be specified, with which sheet metal blanks with a predefined contour can be cut safely and reliably from a continuously conveyed sheet metal strip.

This object is achieved by the features of claim 1. Expedient embodiments of the invention emerge from the features of claims 2 to 18.

In accordance with the invention, a method for cutting a sheet metal blank with a predefined contour from a sheet metal strip conveyed continuously in a direction of transport is proposed, comprising the following steps:

providing at least one laser cutting device having at least one laser cutting head movable both in the direction of transport and in a y-direction running perpendicularly thereto and also having a control arrangement for controlling the movement of the laser cutting head along a cutting path corresponding to the predefined contour,
continuously measuring a first distance between a first strip edge of the sheet metal strip and a fixed first measurement point in the y-direction by means of a first distance measuring arrangement provided upstream of the laser cutting device,
transmitting first measured distance values to the control arrangement,
calculating a corrected cutting path with use of a predefined cutting path and the first measured distance values by means of a control program of the control arrangement, and
producing a cut in the sheet metal strip by moving the laser cutting head along the corrected cutting path.

In accordance with the invention, the first distance of the first strip edge from a fixed first measurement point in the y-direction is measured continuously. The continuously measured first distance values are transmitted to the control arrangement and evaluated there. The position of the strip edge can be detected safely and reliably by means of a distance measuring arrangement, for example an optical, electrical or tactile distance measuring arrangement. For this purpose, the first distance measuring arrangement may comprise components, which are arranged both above and, in opposite arrangement, below the strip edge. For example, the components may be a plurality of light barriers or the like extending in the y-direction. Since the first distance values are measured continuously, for example with a frequency in the range from 50 to 500 Hz, a current first measured distance value is available to the control program at any time. Faults with the correction of the cutting path can therefore be avoided.

In accordance with an advantageous embodiment, a second distance of a second strip edge opposite the first strip edge from a fixed second measurement point in the y-direction is measured continuously by means of a second distance measuring arrangement provided upstream of the laser cutting device. The second distance measuring arrangement is arranged in the y-direction expediently opposite the first distance measuring arrangement. With use of the first and the second measured distance values, it is possible to determine whether a width of the sheet metal strip changes and/or what actually is the width of the sheet metal strip.

The corrected cutting path is thus expediently additionally calculated with use of the second measured distance values. This enables a correction of the cutting path with improved accuracy.

In accordance with a further advantageous embodiment, average values are formed from a plurality of chronologically and locally successive first and/or second distance values, and the average values are used to calculate the corrected cutting path. The average values may be moving average values. Faults caused by nicks and/or unevennesses in the respective strip edge can therefore be avoided.

In accordance with an alternative of the invention, the cutting path is corrected prior to the production of the cut in the sheet metal strip on the basis of at least one average value calculated from the first and/or second distance values. In other words, a predefined cutting path can be displaced, in a simple case of correction, in accordance with a deviation of the sheet metal strip from a target position in the y-direction. In order to calculate the displacement of the cutting path, an average value can also be formed from the first and the second distance value.

In accordance with a further alternative of the invention, the corrected cutting path is calculated continuously during the production of the cut in the sheet metal strip. The calculation of the corrected cutting path is expediently performed in real time. The cutting path is defined in the cutting program by a multiplicity of successive location coordinates. With a continuous correction of the cutting path, the location coordinates running ahead of the laser beam are corrected with use of the first and/or second measured distance value in the y-direction. With the correction of the location coordinates, a distance of the first and/or second distance measuring arrangement from the location coordinates to be corrected in the x-direction is taken into consideration.

In accordance with a further embodiment of the invention, a path of the sheet metal strip covered in the transport direction is measured by means of a path measuring arrangement provided upstream of the laser cutting device. By way of example, the path measuring arrangement may be a measuring wheel bearing against the sheet metal strip, by means of which measuring wheel a path of the sheet metal strip in the direction of transport can be measured. The measured path values are advantageously transmitted to the control arrangement, and the corrected cutting path is calculated by means of the control program with use of the cutting path predefined in order to produce the contour and with use of the measured path values. In other words, the location coordinates of the cutting path not only in the y-direction, but also in the x-direction can be corrected with use of the measured path values delivered by the path measuring arrangement. By way of example, speed fluctuations during the transport of the sheet metal strip can thus be compensated by a correction of the cutting path. This enables a particularly accurate production of the predefined contour of the sheet metal blank.

In accordance with a further advantageous embodiment, the first and/or second measured distance values and measured path values are captured at a distance of at most 2 m, preferably at most 1 m, upstream of the laser cutting device. The first and/or second measured distance values and the measured path values are captured for example at the same distance in the x-direction upstream of the laser cutting device in accordance with a further particularly advantageous embodiment. This simplifies the calculation of the corrected cutting path. An extrapolation necessary for the calculation can be performed in this case on the basis of the same distance of the distance and path measuring arrangements from the laser cutting device.

A device for producing the sheet metal blanks with the predefined contour may comprise a reel for receiving a coil. The sheet metal strip is unwound from the coil and is transported by means of a transport device, for example a roller straightener machine, in the direction of the laser cutting device. The reel may be movable in the y-direction. Further, a control arrangement for controlling a position of the reel in the y-direction may be provided, in such a way that the position of the sheet metal strip with respect to the laser cutting arrangement is kept within a predefined target position range. The target position range can be detected by the first and/or second measuring arrangement. At least one of the first and/or second distance values may thus advantageously be used as a control variable for controlling a y-position of the reel movable in the y-direction, on which reel the sheet metal strip is received in the form of a coil. Undesirable deviations of the sheet metal strip from the target position thereof can thus be minimised. Consequently, the deviations of the sheet metal strip can also be kept low in the y-direction in the region of the first and/or second distance measuring arrangement. The extent of the correction of the cutting path can thus also be kept low. This is advantageous when the correction is only possible within certain limits.

By means of a third distance measuring arrangement, a third distance of the first strip edge from a fixed third measuring point in the y-direction is advantageously measured continuously. By measuring a first and a third distance of the first strip edge at first and third measurement points different from one another in the transport direction, an angle α of the first strip edge with respect to a centreline can be determined, said centreline running parallel to the direction of transport and centrally through the laser cutting device. The angle α can be used to calculate the corrected cutting path. The cutting path can be rotated accordingly in order to compensate for a slanting position of the sheet metal strip given by the angle α.

The third distance measuring arrangement is expediently arranged in the area or upstream of the laser cutting device.

In accordance with an embodiment of the invention, the contour is produced by means of a plurality of laser cutting devices arranged successively in the direction of transport, wherein a partial contour cut is produced with each of the laser cutting devices. A first partial contour cut can thus be produced by means of the laser cutting device, wherein a second partial contour cut is produced by means of a further laser cutting device provided downstream of the laser cutting device, and wherein a predefined further cutting path corresponding to the second partial contour cut is corrected by means of the control program with use of at least the first distance value, such that the further cutting path follows on from an end portion of the first cutting path. It is thus ensured that a successive further cutting path steps in the previous cutting path, even in the case of a correction of the cutting path, and that the first partial contour cut is continued by the second partial contour cut without interruption.

With regard to the continuation of the cutting path by the further cutting path, two alternatives are considered to be advantageous. In accordance with a first alternative, the cutting path and the further cutting path are corrected such that a predefined position of a transfer point at the end of the partial contour cut in the y-direction remains unchanged. In other words, the cutting path is corrected in this case such that it ends at the predefined transfer point. The further cutting path is corrected such that it starts at the predefined transfer point.

In accordance with a further alternative, the cutting path is corrected such that a transfer point at the end of the cutting path is corrected with use of at least the first distance value. In other words, a predefined length of the cutting path remains substantially unchanged in this case. With the correction of the cutting path, the transfer point at the end of the cutting path is displaced in the y-direction.

In accordance with a further embodiment, the distance measuring device/s is/are adjusted in the y-direction relative to the strip edge, such that the strip is always located in the measurement range thereof. In the case of a deviation of the sheet metal strip from the target position thereof, it can thus be ensured at any time that the strip edge does not become distanced from the measurement range of a distance measuring arrangement or does not collide with the distance measuring arrangement.

Exemplary embodiments of the invention will be explained in greater detail hereinafter on the basis of the drawings, in which:

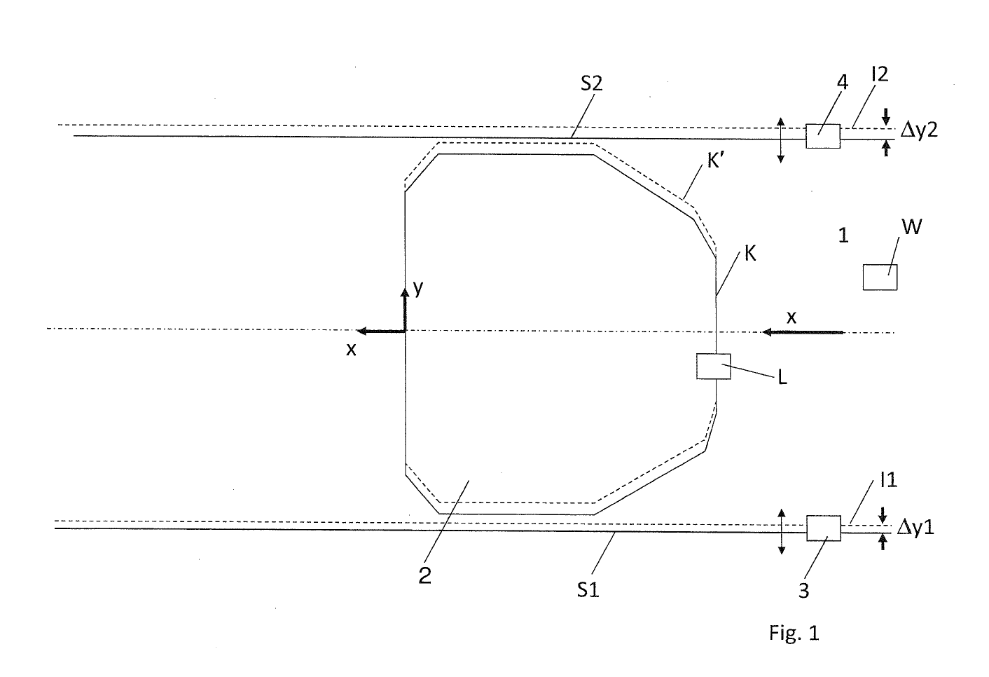

FIG. 1 shows a schematic plan view of a sheet metal strip with a sheet metal blank to be cut out therefrom,

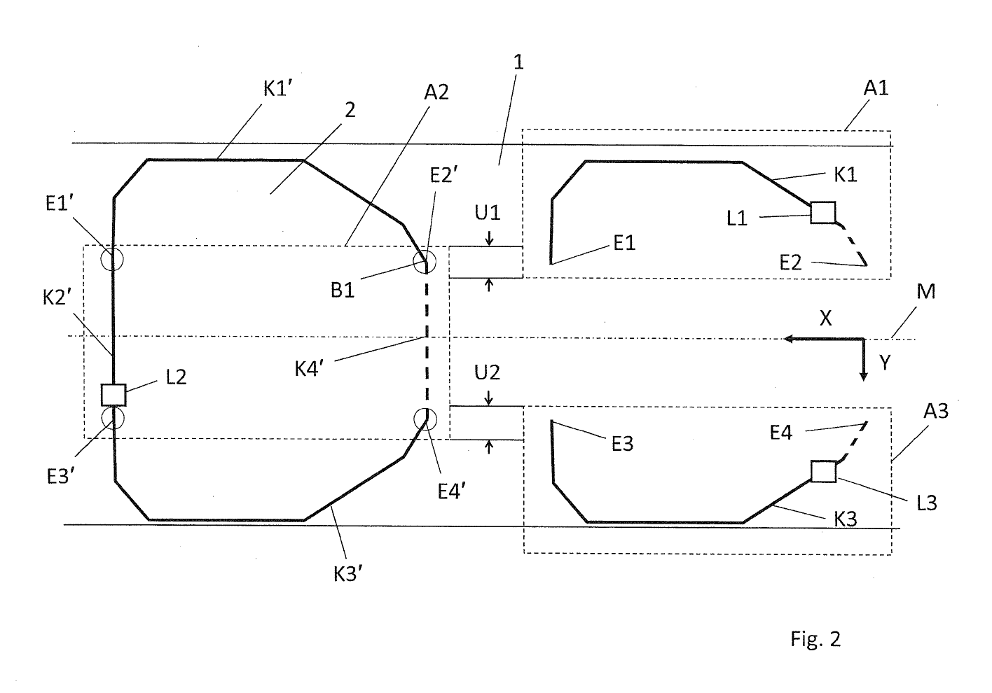

FIG. 2 shows a schematic plan view of the sheet metal strip with partial contour cuts produced therein,

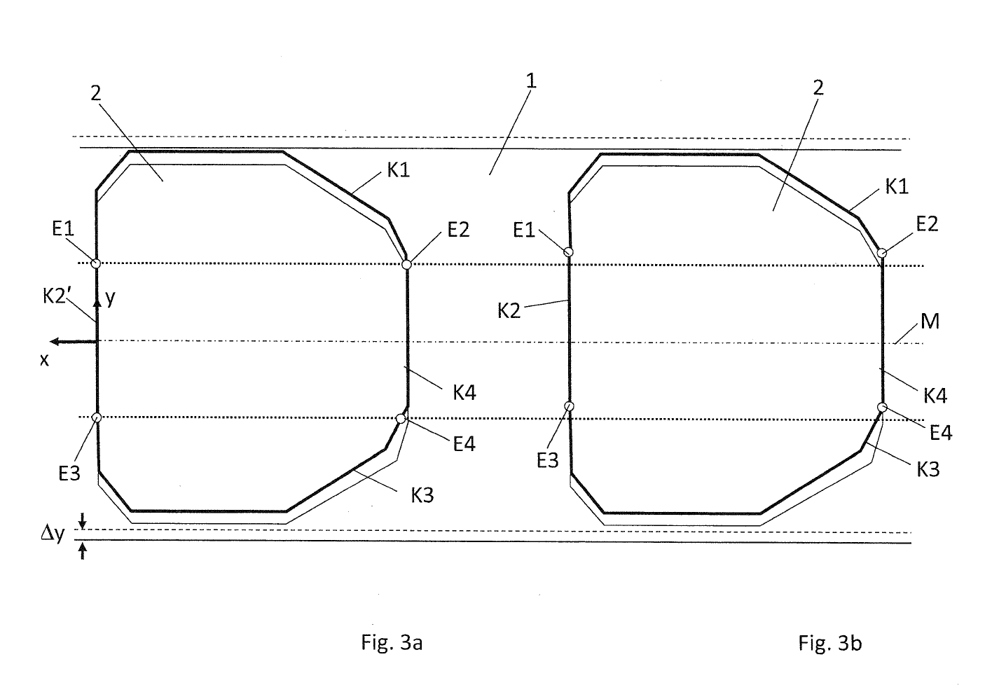

FIG. 3a shows a schematic plan view of the sheet metal strip, wherein the partial contour cuts end at fixed transfer points,

FIG. 3b shows a schematic plan view of the sheet metal strip, wherein the partial contour cuts end at corrected transfer points, and

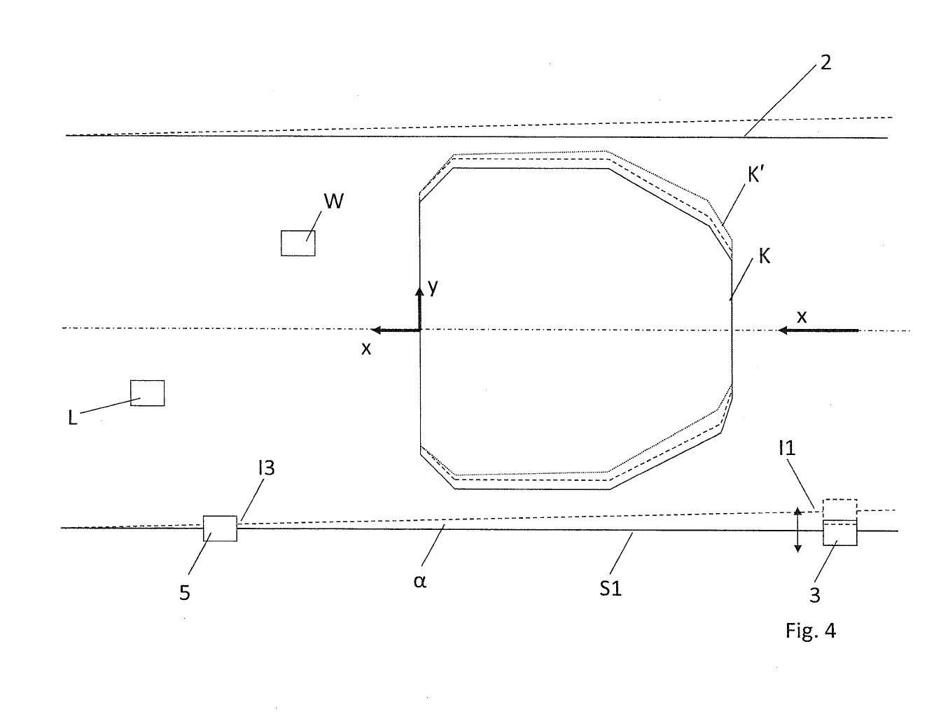

FIG. 4 shows a schematic plan view of the sheet metal strip with a contour and a corrected contour.

FIG. 1 schematically shows a plan view of a sheet metal strip 1. Reference sign K denotes a contour of a sheet metal blank 2. Reference sign x denotes a direction of transport of the sheet metal strip 1. For transport in the direction of transport x, the sheet metal strip 1 is moved continuously by means of a transport arrangement (not shown here). For example, the transport arrangement may be a roller straightener machine, a conveyor belt or the like.

A laser cutting device (not shown here in greater detail) comprises a laser cutting head L, which can be moved both in the direction of transport x and in a y-direction running perpendicularly thereto. In the region of an edge of the sheet metal strip 1, a first distance measuring arrangement 3 is provided upstream of the laser cutting device, by means of which distance measuring arrangement a first actual distance I1 of the sheet metal edge from the first distance measuring arrangement forming the fixed measurement point in the y-direction is measured continuously. The solid line denotes a first target position S1 of a first strip edge of the sheet metal strip 1. A second target position of a second strip edge opposite the first target position S1 is denoted by reference sign S2. In the region of the second strip edge, a second distance measuring arrangement 4 is provided opposite the first distance measuring arrangement 3 in the y-direction. The second distance measuring arrangement 4 also forms a fixed measurement point. A second actual distance I2 of the second strip edge of the sheet metal strip 1 from the second distance measuring arrangement 4 can therefore be measured continuously.

Reference sign W denotes a path measuring arrangement, which is arranged upstream of the laser cutting device. A path covered by the sheet metal strip 1 in the direction of transport x can be detected continuously using the path measuring arrangement W. For example, the path measuring arrangement may be a measuring wheel bearing against the sheet metal strip 1.

FIG. 1 shows the desired contour K of the sheet metal blank 2. If the sheet metal strip 1 were not moved in the direction of transport x, a cutting path of the laser cutting device would correspond to the desired contour K.

However, with the method according to the invention, the sheet metal strip 1 is transported continuously in the direction of transport x. Depending on the transport speed, a cutting path for the laser cutting head L is calculated by means of a control program and gives the desired contour K. The cutting path is dependent in particular on the transport speed, on the maximum movement speed of the laser cutting head L and on the contour K.

In practical operation, it may be that a position of the sheet metal strip 1 deviates from a target position defined by the first S1 and the second target position S2 of the strip edges. For compensation of deviations of this type from the target position, the first actual distance I1 of the strip edge is measured continuously in accordance with the invention by means of the first distance measuring arrangement 3. The measured distance values are transmitted continuously to a control arrangement. A deviation Δy1 of the first strip edge from the first target position S1 is calculated therefrom continuously by means of a control program of the control arrangement. With use of the first deviation Δy1, a cutting path for the laser cutting head L is now corrected such that a further contour K′ produced thereby in the y-direction is likewise displaced by the first deviation Δy1.

In accordance with a variant, it is additionally possible to detect a second actual distance I2 of the second strip edge by means of the second distance measuring arrangement 4. The further measured distance values may likewise be transmitted to the control arrangement. There, a second deviation Δy2 can be determined. A mean value can be formed by means of the control program from the first Δy1 and the second deviation Δy2 and may then form the basis for the correction of the cutting path.

With use of the measured path values delivered by the path measuring arrangement W, fluctuations in the transport speed of the sheet metal strip 1 can additionally be taken into consideration when correcting the cutting path. In other words, the location coordinates defining the cutting path can thus be corrected not only in the y-direction, but also in the x-direction with use of the values delivered by the path measuring arrangement W.

FIG. 2 schematically shows a plan view of the sheet metal strip 1 with laser cutting heads movable thereabove in working areas. Reference sign L1 denotes a first laser cutting head, which is movable in a first working area A1 both in the direction of transport x and in the y-direction running perpendicularly thereto.

A second working area A2 of a second laser cutting head L2 is located in the direction of transport x downstream of the first working area A1. The second laser cutting head L2 is freely movable in the second working area A2 in the x- and y-direction. The first working area A1 and the second working area A2 have a first overlap U1 in the y-direction. The first A1 and the second working area A2 may also overlap in the x-direction.

Reference sign M denotes a centreline of the laser cutting device. The laser cutting device comprises a third laser cutting head L3, of which the third working area A3 is arranged symmetrically to the first working area A1 of the first laser cutting head L1 with respect to the centreline M. In other words, the third working area A3 is located upstream of the second working area A2. Similarly to the first working area A1, the third working area has an overlap U2 with the second working area A2 in the y-direction. The third working area A3 and the second working area A2 may also overlap in the x-direction.

To produce the sheet metal blank 2, the first partial contour cut K1 is produced with the first laser cutting head L1. Simultaneously thereto, a third partial contour cut K3 can be produced with the third laser cutting head L3. The third partial contour cut K1 has a first endpoint E1 and second endpoint E2. The third partial contour cut K3 has a third endpoint E3 and a fourth endpoint E4. The corresponding endpoints of the previously produced first partial contour cut K1′ are denoted by E1′ and by E2′. The endpoints of a previously produced third partial contour cut K3′ are denoted by E3′ and E4′.

In FIG. 2, a second partial contour cut is denoted by reference sign K2′ and a fourth partial contour cut is denoted by reference sign K4′, which partial contour cuts are to connect the first K1′ and third partial contour cut K3′ already produced. Reference sign B1 denotes a first transfer area, which is located in the second working area A2 and is stationary, similarly to the working areas A1, A2, A3.

Due to the continuous movement of the sheet metal strip 1 in the direction of transport x, the first partial contour cut K1 and optionally the third partial contour cut K3 are moved from the first working region A1, and where applicable the third working area A3 is moved into the second working area A2. As soon as the first end E1 has entered the second working area E2, the second laser cutting head L2 is moved into the first transfer area B1. The second laser cutting head L2 follows on from the end portion of the first partial contour cut K1 and thus starts to produce the second partial contour cut K2. FIG. 2 shows the situation just before completion of the second partial contour cut K2. Immediately after the completion of the second partial contour cut K2, the second laser cutting head L2 is moved back into the first transfer area B1 so as to then produce the fourth partial contour cut K4 indicated by the interrupted line.

In accordance with the invention, the cutting paths corresponding to the partial contour cuts K1, K2′, K3 and K4′ are corrected with use of the first deviation Δy1 and/or the second deviation Δy2, such that a deviation of the position of the sheet metal strip 1 from the target position is compensated for.

FIGS. 3a and 3b show variants with respect to the production of a contour formed from a number of partial contour cuts. The strip edges of the sheet metal strip 1 displaced in the y-direction by the magnitude Δy are shown by interrupted lines. E1, E2, E3 and E4 denote endpoints or transfer points, at which partial contour cuts K1, K2, K3, K4 start or end.

In the first variant shown in FIG. 3a, the transfer points E1, E2, E3, E4 relative to the centreline M remain unchanged. In other words, the displacement of the sheet metal strip 1 in the y-direction is compensated for in this case by a modification of the geometry of the partial contour cuts K1, K2, K3, K4.

In the second variant shown in FIG. 3b, the partial contour cuts K1, K2, K3, K4 remain unchanged in terms of geometry. The partial contour cuts K1, K2, K3, K4 are displaced by the magnitude Δy. Consequently, the transfer points E1, E2, E3, E4 are also displaced by the magnitude Δy.

With the method variant shown in FIG. 4, a third distance measuring arrangement 5 is provided downstream of the first distance measuring arrangement 3, by means of which third distance measuring arrangement a third actual distance I3 of the first strip edge of the sheet metal strip 1 can be measured. An angle α can be determined by means of the control program from a comparison of the first actual distance I1 and the third actual distance I3 and describes a slanted position of the sheet metal strip 1 with respect to the x-direction. It is possible with use of the angle α to displace the originally predefined position of the contour K not only in the y-direction, but also to rotate said position by the angle α. In this case, the corrected contour K′ shown by the dotted line is produced.

### LIST OF REFERENCE SIGNS

1 sheet metal strip
2 sheet metal blank
3 first distance measuring arrangement
4 second distance measuring arrangement
5 third distance measuring arrangement
A1 first working area
A2 second working area
A3 third working area
E1 first transfer point
E2 second transfer point
E3 third transfer point
E4 fourth transfer point
I1 first actual distance
I2 second actual distance
I3 third actual distance
K contour
K1 first partial contour cut
K2 second partial contour cut
K3 third partial contour cut
K4 fourth partial contour cut
L laser cutting head
L1 first laser cutting head
L2 second laser cutting head
L3 third laser cutting head
M centreline
S1 first target position of the strip edge
S2 second target position of the strip edge
U1 first overlap area
U2 second overlap area
U3 third overlap area
U4 fourth overlap area
W path measuring arrangement
x direction of transport
α angle of the strip edge
Δy1 first deviation
Δy2 second deviation
Δy deviation in the y-direction

1. A method for cutting a sheet metal blank with a predefined contour from a sheet metal strip conveyed continuously in a direction of transport comprising the following steps:
providing at least one laser cutting device having at least one laser cutting head movable both in the direction of transport and in a y-direction running perpendicularly thereto and also having a control arrangement for controlling the movement of the laser cutting head along a cutting path corresponding to the predefined contour,
continuously measuring a first distance of a first strip edge of the sheet metal strip from a fixed first measurement point in the y-direction by means of a first distance measuring arrangement provided upstream of the laser cutting device,
transmitting first measured distance values to the control arrangement,
calculating a corrected cutting path with use of a predefined cutting path and the first measured distance values by means of a control program of the control arrangement, and
producing a cut in the sheet metal strip by moving the laser cutting head along the corrected cutting path.

2. The method according to claim 1, wherein a second distance of a second strip edge opposite the first strip edge from a fixed second measurement point in the y-direction is measured continuously by means of a second distance measuring arrangement provided upstream of the laser cutting device.

3. The method according to claim 1, wherein the corrected cutting path is additionally calculated with use of the second measured distance values.

4. The method according to claim 1, wherein at least one average value is formed from a plurality of chronologically or locally successive first and/or second measured distance values, and the average values are used to calculate the corrected cutting path.

5. The method according to claim 1, wherein the cutting path is corrected on the basis of at least one average value calculated from the first and/or second measured distance values, prior to the formation of the cut in the sheet metal strip.

6. The method according to claim 1, wherein the corrected cutting path is calculated continuously during the production of the cut in the sheet metal strip.

7. The method according to claim 1, wherein the calculation of the corrected cutting path is performed in real time.

8. The method according to claim 1, wherein a path covered by the sheet metal strip in the direction of transport is measured continuously by means of a path measuring arrangement provided upstream of the laser cutting device.

9. The method according to claim 1, wherein the measured path values are transmitted to the control arrangement and the corrected cutting path is calculated by means of the control program with use of the cutting path predefined in order to produce the contour and with use of the measured path values.

10. The method according to claim 1, wherein the first and/or second measured distance values and the measured path values are detected at a distance of at most 2 m, preferably at most 1 m, upstream of the laser cutting device.

11. The method according to claim 1, wherein the first and/or second measured distance values and the measured path values are detected approximately at the same distance upstream of the laser cutting device.

12. The method according to claim 1, wherein at least one of the first and/or second distance values is used as a control variable for controlling a y-position of a reel movable in the y-direction, on which reel the sheet metal strip is received in the form of a coil.

13. The method according to claim 1, wherein a third distance of the first strip edge from a fixed third measurement point in the y-direction is measured continuously by means of a third distance measuring arrangement.

14. The method according to claim 1, wherein the third distance measuring arrangement is arranged in the area or upstream of the laser cutting device.

15. The method according to claim 1, wherein a first partial contour cut is produced by means of the laser cutting device, wherein a second partial contour cut is produced by means of a further laser cutting device provided downstream of the laser cutting device, and wherein a predefined further cutting path corresponding to the second partial contour cut is corrected by means of the control program with use of at least the first distance value, such that the further cutting path steps in an end portion of the first cutting path.

16. The method according to claim 1, wherein the cutting path and the further cutting path are corrected such that a predefined position of a transfer point at the end of the first partial contour cut remains unchanged.

17. The method according to claim 1, wherein the cutting path is corrected such that a transfer point at the end of the cutting path is corrected with use with the first distance value.

18. The method according to claim 1, wherein the distance measuring arrangement is adjusted in the y-direction with respect to the strip edge, such that the strip edge is always located in the measurement range thereof.
